(19) United States
(12) Patent Application Publication
(10) Pub. No.: US 2009/0073134 A1
(43) Pub. Date: Mar. 19, 2009

(54) Dual-mode touch screen of a portable apparatus

(75) Inventors: Cheng-Wen Huang, Taipei Hsien (TW); Chun-Chi Chen, Taipei Hsien (TW)

Correspondence Address: BIRCH STEWART KOLASCH & BIRCH, PO BOX 747, FALLS CHURCH, VA, 22040-0747, US

(73) Assignees: GIGA-BYTE Communications, Inc.; GIGA-BYTE TECHNOLOGY CO., LTD.

(21) Appl. No.: 12/081,825

(22) Filed: Apr. 22, 2008

(30) Foreign Application Priority Data
Sep. 19, 2007 (TW) 096134844

(51) Int. Cl. G06F 3/041

(52) U.S. Cl. 345/173; 345/174

(57) ABSTRACT

A dual-mode touch panel for use on a screen of a mobile device, includes a substrate; a first touch panel, attached to a first side of the substrate; and a second touch panel, attached to a second side of the substrate.

### CROSS-REFERENCE TO RELATED APPLICATIONS

This nonprovisional application claims priority under 35 U.S.C. § 119(a) on Patent Application No. 096134844, filed in Taiwan on Sep. 19, 2007, the entirety of which is incorporated herein by reference.

### BACKGROUND OF THE INVENTION

1.Field of the Invention

The present invention generally relates to a touch screen, and more particularly, to a dual-mode touch screen of a portable apparatus.

2. Background of the Invention

Along with the improvement of the semi-conductor technology, the mobile phone becomes smaller and more convenient for a user to carry.

Although the small size of the mobile phone is the current market trend, a mobile phone with a big-size screen is convenient for a user to easily review the images and characters. For this purpose, the designer of a mobile phone usually removes a group of keys from the phone to get enough room for a bigger size screen. Thus, a touch panel is equipped on the screen of the mobile phone, and a virtual keyboard can be displayed on the screen of the mobile phone for a user to operate with fingers or stylus for replacing the removed physical keys. When a virtual key of the virtual keyboard on the screen of the mobile phone is selected, a function such as making a phone call or opening a document can be executed correspondingly.

The touch screen of a mobile device generally can be classified into two types, i.e., the resistive type touch screen and the capacitive type touch screen. The resistive type touch screen is now a commonly used technology, and the principle of which is to calculate the coordinates according to the voltage drop. The X-axis and the Y-axis are separately driven by a pair of 0-5V voltage. When the resistive touch panel (screen) is touched or pressed, the circuit of the resistive touch panel becomes a closed loop, and then a voltage drop is generated. According to the proportion of the generated voltage drop, a controller of the resistive touch panel can calculate the coordinates. Compared with the resistive type touch screen, the capacitive type touch screen is totally different and is much simpler in structure. Basically, the capacitive type touch screen has an Indium Tin Oxide (ITO) conductive glass. By discharging the ITO conductive glass in the four corners thereof, there will be an even-distributed electric field established on the surface of the ITO conductive glass. When the glass is touched by any conductive matter such as human fingers, a small amount of current on the ITO conductive glass is absorbed. The controller of capacitive touch screen will measure the proportion of the absorbed current to calculate the value of X-axis and Y-axis.

Because those two types of touch screen are separately used in different mobile devices, none of the prior art disclose an apparatus or a method using these two types of touch screen simultaneously in a single touch screen.

### SUMMARY OF THE INVENTION

To achieve the above-mentioned objects, according to a first aspect of the present invention, a dual-mode touch panel for use on a screen of a mobile device, includes: a substrate; a first touch panel, attached to a first side of the substrate; and a second touch panel, attached to a second side of the substrate

According to a second aspect of the present invention, a dual-mode touch panel for a display screen of a mobile device, includes: a substrate; a resistive touch panel, attached to a first side of the substrate; and a capacitive touch panel, attached to a second side of the substrate.

According to a third aspect of the present invention, a method for operating a dual-mode touch screen includes determining whether the first touch panel or the second touch panel is activated; if it is determined that the first touch panel is activated, showing at least one icon corresponding to the first touch panel on the first touch panel; and executing a function of the at least one icon corresponding to the first touch panel; and if it is determined that the second touch panel is activated, showing at least one icon corresponding to the second touch panel on the second touch panel; and executing a function of the at least one icon corresponding to the second touch panel.

According to a fourth aspect of the present invention, an information processing apparatus with dual-mode touch panel, includes a first touch panel for generating a voltage drop; a first controller electrically connected to the first touch panel for calculating a value of a coordinate axis according to the voltage drop; a second touch panel for generating a change of capacitance; a second controller electrically connected to the first touch panel for calculating the value of the coordinate axis according to the change of the capacitance; and a multiplexer, electrically connected to the first and second controller, for receiving a first signal from the first controller and a second signal from the second controller and selectively outputting one of the first and second signals to a processing system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exploded view of a dual-mode touch panel according to an embodiment of the present invention;

FIG. 2 is a side view of a dual-mode touch panel according to an embodiment of the present invention;

FIG. 3 is a mobile device with the dual-mode touch panel according to an embodiment of the present invention;

FIG. 4 is a cross-sectional view of a mobile device with the dual-mode touch panel according to an embodiment of the present invention;

FIG. 5 shows the icons corresponding to the second touch panel displayed on the screen with a dual-mode touch panel according to an embodiment of the present invention;

FIG. 6 shows the icons corresponding to the first touch panel displayed on the screen with a dual-mode touch panel according to an embodiment of the present invention;

FIG. 7 shows the icons corresponding to the first and second touch panels simultaneously displayed on the screen with a dual-mode touch panel according to an embodiment of the present invention;

FIG. 8 is a block diagram of an information processing circuit according to an embodiment of the present invention; and

FIG. 9 is a flow chart for operations of the first and second touch panels according to an embodiment of the present invention.

### DETAILED DESCRIPTION OF THE ILLUSTRATED EMBODIMENTS

The present invention will now be described in detail with reference to the accompanying drawings, wherein the same reference numerals will be used to identify the same or similar -elements throughout the several views. It should be noted that the drawings should be viewed in the direction of orientation of the reference numerals.

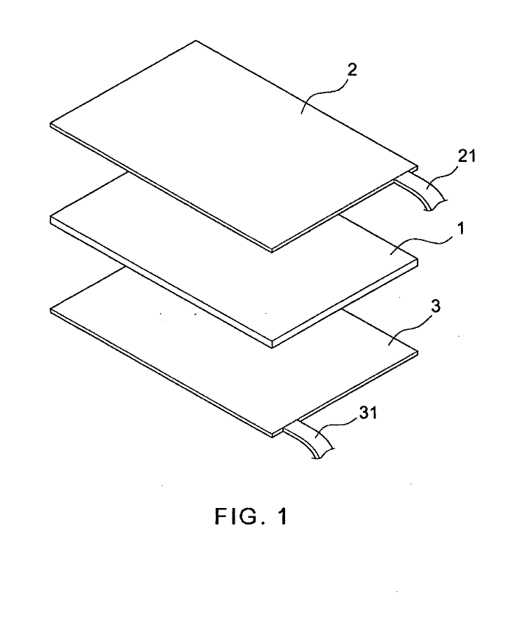

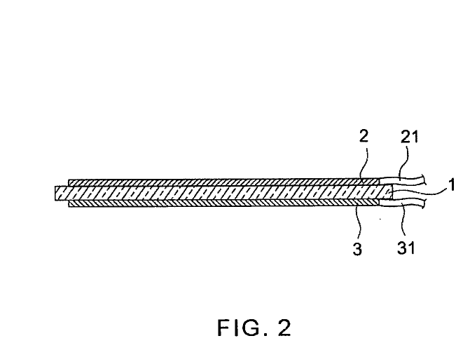

Referring to FIG. 1 and FIG. 2, a dual-mode touch panel according to an embodiment of the present invention includes: a substrate 1, a first touch panel 2, and a second touch panel 3. The substrate is a plate, made of any kind of transparent glass or transparent plastic. The first touch panel 2 is a resistive touch panel, attached on one side of the substrate 1. A flexible wire 21 such as Flat Flexible Cable (FFC) is electrically connected to the first touch panel 2 and a main circuit board of the mobile device (not shown), for transmitting the signal of the first touch panel 2 to the main circuit board for processing.

The second touch panel 3 is a capacitive touch panel, attached on the other side of the substrate 1. A flexible wire 31 such as Flat Flexible Cable (FFC) is electrically connected to the second touch panel 3 and the main circuit board of the mobile device (not shown), for transmitting the signal of the second touch panel 3 to the main circuit board for processing.

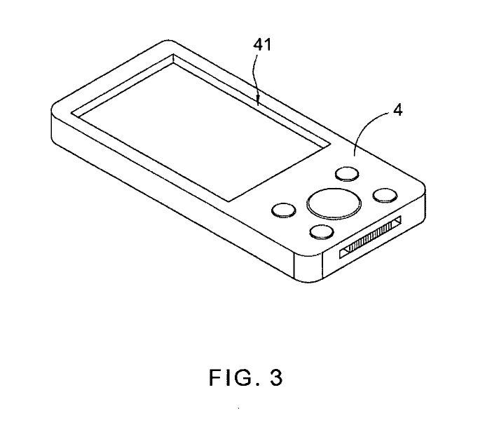

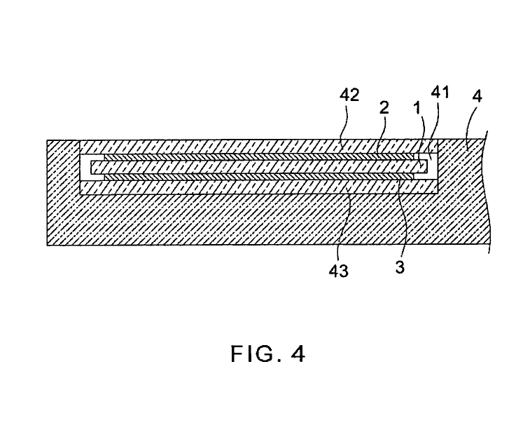

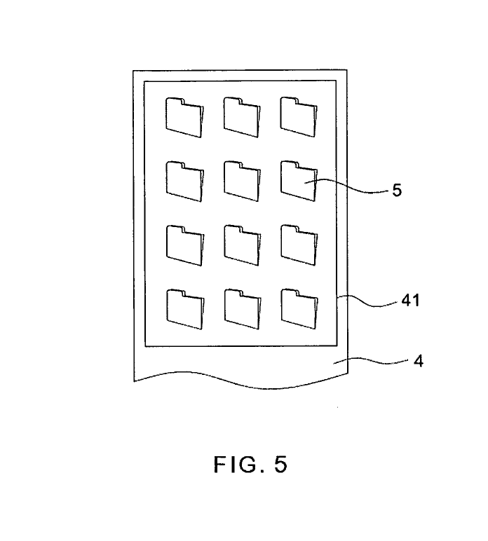

Referring to FIG. 3 and FIG. 4, the illustrated dual-mode touch panel is installed under a transparent protective film 42 of a display screen 41 of a mobile device 4. A user can press the function key 43 to switch the display mode to a small icon mode or a big icon mode. As shown in FIG. 5, when the display screen 44 displays the big icons 5 (big icon mode), the user can select one of big icons 5 by touching the protective film 42 with fingers or a stylus. In this case, the second touch panel 3 will sense the touch action and then generate a signal to the operating system. Through the flexible conductive wires 31 of the second touch panel 2, the generated signal of the second touch panel 3 will be transmitted to the main circuit board of the mobile device 4 for processing, and a function corresponding to the selected big icon can be displayed or executed.

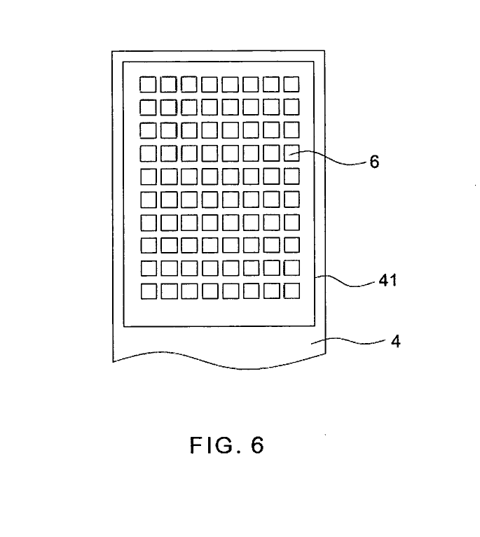

When a user switches the display mode to the small icon mode, the screen 44 will display the small icons 6 as shown in FIG. 6. A user can press the transparent protective film 42 with a stylus to select one of the small icons 6. When the first touch panel 2 is used to sense the pressure, it will generate a signal to the operating system. Through the flexible conductive wires 21 of the first touch panel 2, the generated signal of the first touch panel 2 will be transmitted to the main circuit board of the mobile device 4 for processing, and a function corresponding to the selected small icon 6 can be displayed or executed.

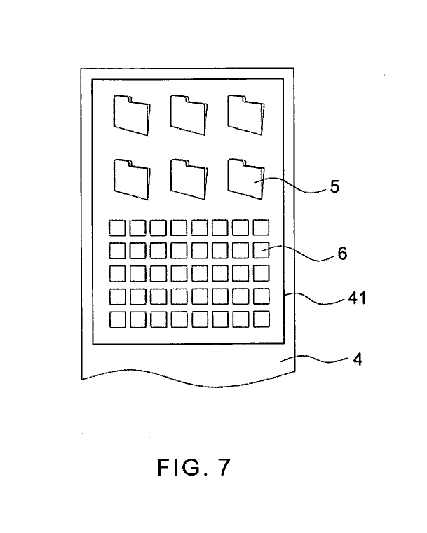

Referring to FIG. 7, the big icons 5 and the small icons 6 are displayed simultaneously on the screen 44. When one of the big icons 5 is selected by touching the transparent protective film 42 with fingers or a stylus, the second touch panel 3 is used to sense the touch action and then generates a signal for transmitting to the main circuit board (not shown in the drawings) of the mobile device for processing, and then a function of the selected big icon 5 can be executed or displayed.

When the user presses the transparent protective film 42 with a stylus to select one of the small icons 6, the first touch panel 2 is used to sense the pressure and then generates a signal for processing. Through the flexible conductive wires 21 of the first touch panel 2, the signal can be transmitted to the main circuit board of the mobile device, and then a function of the selected small icon 6 can be executed or displayed.

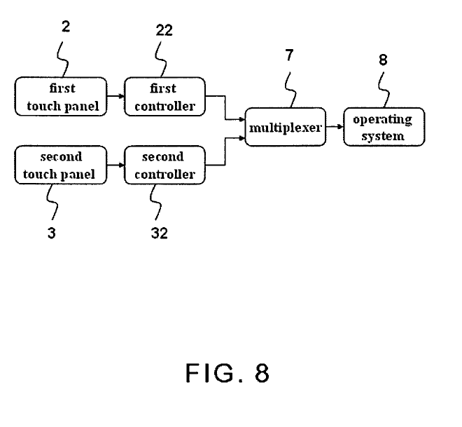

FIG. 8 shows a block diagram of an information processing circuit according to an embodiment of the present invention. As shown in FIG. 8, the information processing circuit comprises: a first touch panel 2, a first controller (e.g., a resistive driver) 22, a second touch panel 3, a second controller (e.g., a capacitive driver) 32, and a multiplexer 7.

The first touch panel 2, e.g., a resistive touch panel, can be pressed to generate a voltage drop. The first controller 22, electrically connected to the first touch panel 2, can calculate the value of the coordinate according to the voltage drop.

The second touch panel 3, e.g., a capacitive touch panel, can be touched to generate a change of capacitance. The quantity of the transparent electric charge on the surface of the ITO conductive glass can be changed because the transparent electric charge can be neutralized by the static electricity of the fingers of the user.

The second controller 32, electrically connected to the second touch panel 3, can calculate the value of coordinate axis according to the change of the current value caused by the change of the capacitance.

The multiplexer 7 is electrically connected to the first controller 22 and the second controller 32. The multiplexer 7 can receive more than one signal, and only outputs one signal at a time. Therefore, when the signals from the first controller 22 and the second controller 32 are transmitted to the multiplexer 7, the multiplexer 7 will selectively output one of the signals from the first controller 22 and the second controller 32.

When receiving the signal of the first touch panel 2, the operating system 8 of the mobile device 4 can show at least one icon on the first touch panel 2 or execute a function corresponding to the icon. On the contrary, when receiving the signal of the second controller 32, the operating system 8 of the mobile device 4 can show at least one icon on the second touch panel 3 or execute a function corresponding to the icon.

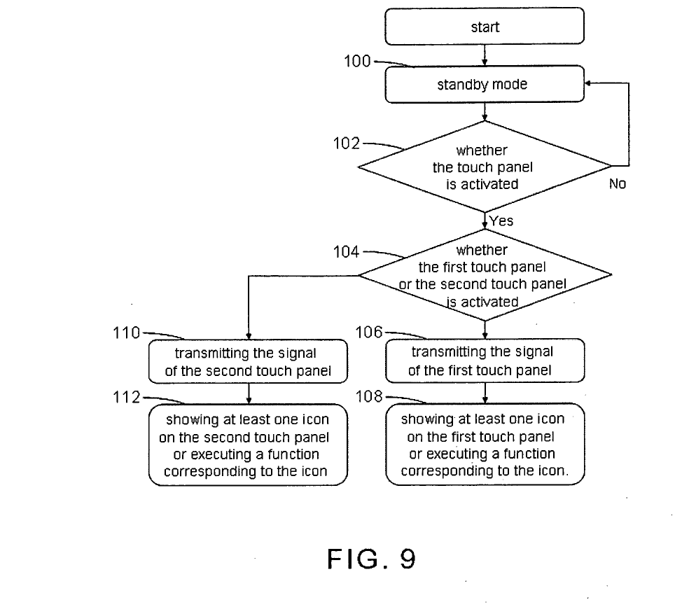

FIG. 9 is a flow chart for operations of the first and second touch panels according to an embodiment of the present invention.

First, in step 100, the mobile device is in the standby mode.

In step 102, it is determined that whether the touch panel is activated. If the touch panel is not activated, the mobile device keeps in the standby mode. If the touch panel is activated, the process goes to step 104.

In step 104, it is determined whether the first touch panel 2 or the second touch panel 3 is activated. If the first touch panel 2 is activated, the process goes to step 106 for transmitting the signal of the first touch panel 2 to the main circuit board of the mobile device 4, and then the process goes to step 108. In step 108, the operating system 8 of the mobile device 4 can show at least one icon corresponding to the first touch panel 2 on the first touch panel 2 so that a function corresponding to the at least one icon on the first touch panel 2 can be executed if selected by the user.

On the other hand, if the second touch panel 3 is activated, the process goes to step 110 for transmitting the signal of the second panel 3 to the main circuit board of the mobile device, and then the process goes to step 112. In step 112, the operating system 8 of the mobile device 4 can show at least one icon corresponding to the second touch panel 3 on the second touch panel 3 so that a function corresponding to the at least one icon on the second touch panel 3 can be executed if selected by the user.

It should be noted that the first touch panel 2 and the second touch panel 3 can also be activated simultaneously to respectively show at least one icon corresponding to the first touch panel 2 and at least one icon corresponding to the second touch panel 3 at the same time, as shown in FIG. 7. In this situation, the signal of the first panel can be transmitted to the operating system, showing at least one icon corresponding to the first touch panel 2 on the first touch panel 2 so that a function corresponding to the icon of the first touch panel can be executed if selected by the user. Similarly, the signal of the second touch panel 3 can also be transmitted to the operating system, showing at least one icon corresponding to the second touch panel 3 on the second touch panel so that a function corresponding to the icon of the second touch panel 3 can be executed if selected by the user. Because the substrate is made of transparent glass or transparent plastic, a user can see both the icon(s) of the first touch panel and the icon(s) of the second touch panel at the same time. The icon(s) of the first touch panel and the icon(s) of the second touch panel may have different icon size, but both of them can be operated according to the selection of a user.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A dual-mode touch panel for use on a screen of a mobile device, comprising:
a substrate;
a first touch panel, attached to a first side of the substrate; and
a second touch panel, attached to a second side of the substrate.

2. The dual-mode touch panel according to claim 1, wherein the substrate is a plate made of transparent glass.

3. The dual-mode touch panel according to claim 1, wherein the substrate is a plate made of transparent plastic.

4. The dual-mode touch panel according to claim 1, wherein the first touch panel is a resistive touch panel.

5. The dual-mode touch panel according to claim 1, wherein one side of the first touch panel is electrically connected to a flexible conductive wire.

6. The dual-mode touch panel according to claim 5, wherein the flexible wire is electrically connected to a main circuit board of the mobile device.

7. The dual-mode touch panel according to claim 1, wherein the second touch panel is a capacitive touch panel.

8. The dual-mode touch panel according to claim 7, wherein one side of the second touch panel is electrically connected to a flexible conductive wire.

9. The dual-mode touch panel according to claim 8, wherein the flexible wire is electrically connected to a main circuit board of the mobile device.

10. A dual-mode touch panel for a display screen of a mobile device, comprising:
a substrate;
a resistive touch panel, attached to a first side of the substrate; and
a capacitive touch panel, attached to a second side of the substrate.

11. The dual-mode touch panel according to claim 10, wherein the substrate is a plate made of transparent glass.

12. The dual-mode touch panel according to claim 10, wherein the substrate is a plate made of transparent plastic.

13. The dual-mode touch panel according to claim 10, wherein the resistive touch panel is electrically connected to a first flexible wire, and the first flexible wire is electrically connected to a main circuit board of the mobile device.

14. The dual-mode touch panel according to claim 13, wherein the capacitive touch panel is electrically connected to a second flexible wire, and the second flexible wire is electrically connected to a main circuit board of the mobile device.

15. A method for operating a dual-mode touch screen, the dual-mode touch screen having a first touch panel and a second touch panel, the method comprising:
determining whether the first touch panel or the second touch panel is activated;
if it is determined that the first touch panel is activated,
showing at least one icon corresponding to the first touch panel on the first touch panel; and
executing a function of the at least one icon corresponding to the first touch panel; and
if it is determined that the second touch panel is activated,
showing at least one icon corresponding to the second touch panel on the second touch panel; and
executing a function of the at least one icon corresponding to the second touch panel.

16. The method according to claim 15, wherein the first touch panel is a resistive touch panel.

17. The information processing method according to claim 15, wherein the second touch panel is a capacitive touch panel.

18. An information processing apparatus with dual-mode touch panel, comprising:
a first touch panel for generating a voltage drop;
a first controller electrically connected to the first touch panel for calculating a value of a coordinate axis according to the voltage drop;
a second touch panel for generating a change of capacitance;
a second controller electrically connected to the first touch panel for calculating the value of the coordinate axis according to the change of the capacitance; and
a multiplexer, electrically connected to the first and second controller, for receiving a first signal from the first controller and a second signal from the second controller and selectively outputting one of the first and second signals to a processing system.

19. The information processing apparatus according to claim 18, wherein the first touch panel is a resistive touch panel.

20. The information processing apparatus according to claim 18, wherein the second touch panel is a capacitive touch panel.
